(19) United States
(12) Patent Application Publication
(10) Pub. No.: US 2008/0187388 A1
(43) Pub. Date: Aug. 7, 2008

(54) Mechanical pencil with rotating cylinder

(76) Inventor: Wil Adams, Murrayville, GA (US)

Correspondence Address: Wil Adams, 5439 Mt. Vernon Rd., Murrayville, GA, 30564, US

(21) Appl. No.: 11/702,049

(22) Filed: Feb. 5, 2007

(51) Int. Cl. B43K 21/02; B43K 21/14

(52) U.S. Cl. 401/55

(57) ABSTRACT

The mechanical pencil with a rotating cylinder is comprised of three major parts. The mechanical pencil portion, the cylinder portion, and the eraser cap. The mechanical pencil portion is a typical mechanical pencil that is operated by inserting a graphite stick and clicking a button to advance the graphite stick. The cylinder potion has one large cylinder containing several smaller cyliders that hold one graphite stick each. The eraser cap is placed on top of the rotating cylinder and prevents the graphite sticks from falling out the back of the rotating cylinder. The eraser cap is a standard mechanical pencil eraser cap used for making corrections. The pencil is operated by turning the large cylinder with the hand until a single graphite stick falls into the mechanical pencil portion.

### FIELD OF THE INVENTION

The present invention relates to mechanical pencils and, more particularly, to mechanical pencils with rotating cylinders that prevent breaking and jamming of graphite sticks and contain many graphite sticks.

### BACKGROUND OF THE INVENTION

Most mechanical pencils can only carry a small amount of graphite sticks without jamming. Many times in high school or college my mechanical pencil would run out of graphite sticks during a test. I would have to stop writing and look through my book bag for more graphite sticks. Then I would try to put as many graphite sticks in the pencil as possible so I would not run out again. This usually caused the mechanical pencil to jam or crush the graphite sticks. Mechanical pencils are always jamming and breaking graphite. Since mechanical pencils can only hold a small amount of graphite, a person must carry graphite sticks with them at all times. This can be very troublesome for students. My mechanical pencil solves the three major problems that are inherent in all standard mechanical pencils, jamming, breaking graphite sticks, and the inability to carry large amounts of graphite sticks.

To my knowledge there are no mechanical pencils that rotate while preventing breaking, jamming, and allowing the user to carry large amounts of graphite sticks within the pencil.

Increasing the size of a mechanical pencil can allow for more graphite sticks to be placed inside the pencil, but the mechanical pencil must be more bulky and costly. A larger size mechanical pencil does not solve the duel problems of jamming and breaking graphite sticks.

It is therefore an object of the invention to carry large amounts of graphite sticks inside of a mechanical pencil with a rotating cylinder.

It is another object of the invention to prevent graphite sticks from jamming the mechanical pencil.

It is another object of the invention to prevent the mechanical pencil from breaking graphite sticks.

### SUMMARY OF THE INVENTION

The mechanical pencil with a rotating cylinder is comprised of three major parts. The mechanical pencil portion, the cylinder portion, and the eraser cap. The mechanical pencil portion is a typical mechanical pencil that is operated by inserting a graphite stick and clicking a button to advance the graphite stick. The cylinder portion has one large cylinder containing several smaller cyliders that hold one graphite stick each. The eraser cap is placed on top of the rotating cylinder and prevents the graphite sticks from falling out the back of the rotating cylinder. The eraser cap is a standard mechanical pencil eraser cap used for making corrections. The pencil is operated by turning the large cylinder with the hand until a single graphite stick falls into the mechanical pencil portion.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a lengthwise view of a mechanical pencil with a rotating cylinder;

FIG. 2 is a bottom view of a mechanical pencil that fits into element 11;

FIG. 3 is a bottom view of a rotating cylinder that fits into element 10 and element 12; and

FIG. 4 is a front view of an eraser cap that fits on top of element 11.

For purposes of clarity and brevity, like elements and components will bear the same designations and numbering throughout the Figures.

### DESCRIPTION OF THE PREFERRED EMBODIMENT

FIG. 1 is a complete view of the mechanical pencil 10 with rotating cylinder 11 consisting of three major portions attached together. Three major portions of the mechanical pencil 10 with rotating cylinder 11 are attached together by friction generated between element 12, element 11, and element 10. Element 12 sits atop element 11, and is attached by friction between the two elements. Element 11 sits atop element 10, and is attached by friction to element 10. Element 12 while being attached by friction to element 11, remains stationary and rotates with element 11, not separately. There is no intention for element 11 to rotate independently.

FIG. 2 depicts element 10 detached from elements 11 and 12. Element 10 consist of a standard mechanical pencil 10 without a standard body or eraser. Element 10 receives a single graphite stick from element 11. Once the single graphite stick has been received, the user of the mechanical pencil 10 with rotating cylinder 11 must click the side button of element 10 until the single graphite stick progresses far enough so that it may be used to write with. Element 10 varies from a standard mechanical pencil 10 in that the hollow inside is obstructed except for a small opening that will allow a single graphite stick to descend into element 10. Element 10 may be manufactured using any material suitable for literary writing and corrections. Element 10 must not be glued or attached permanently to element 11. Element 10 must be removable from element 11.

FIG. 3 depicts element 11 and element 13. Element 11 is a hollow cylinder containing several smaller hallow cyliders. Element 11 may be constructed of plastic, although any material that can withstand the rigors of writing may be used. Element 11 rotates on top of element 10 by the user turning element 11 with their hand. Element 11 should be turned slightly until a single graphite stick falls into element 10. Elements 13 are smaller cyliders contained within element 11. Elements 13 may be constructed of plastic or any other material capable of containing a single graphite stick. Each individual hollow cylider of elements 13 should contain a single graphite stick each. The graphite sticks are to be placed in elements 13 by removing element 12 exposing elements 13. Then the user must place a single graphite stick in each cylider of elements 13. Now the user must place element 12 back on top of element 11 which contains elements 13. Element 11 must not be glued or permanently attached to element 12 or element 10. Element 11 must be removable from element 12 and element 10.

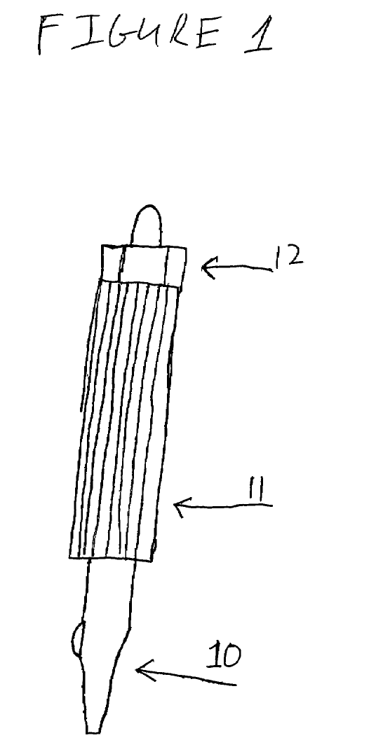

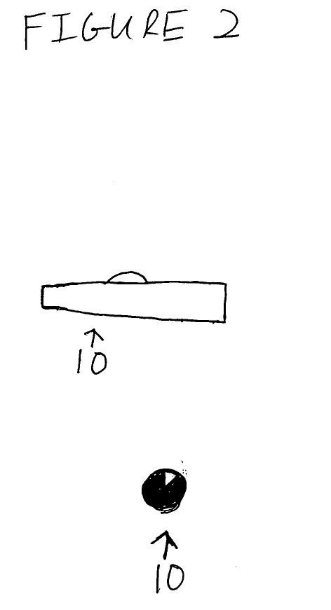

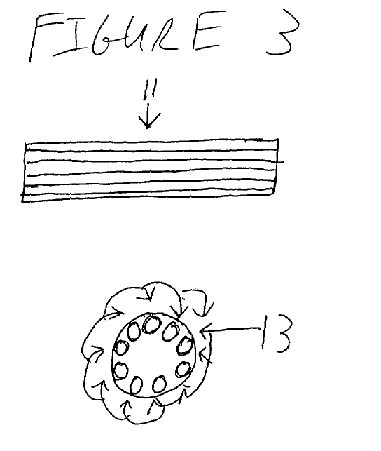

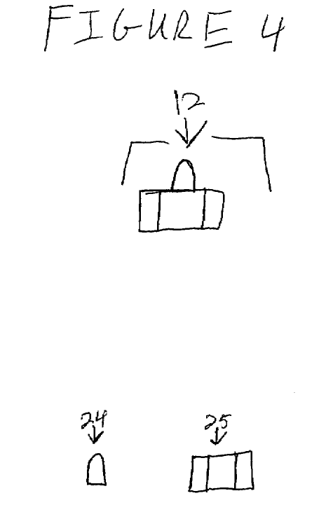

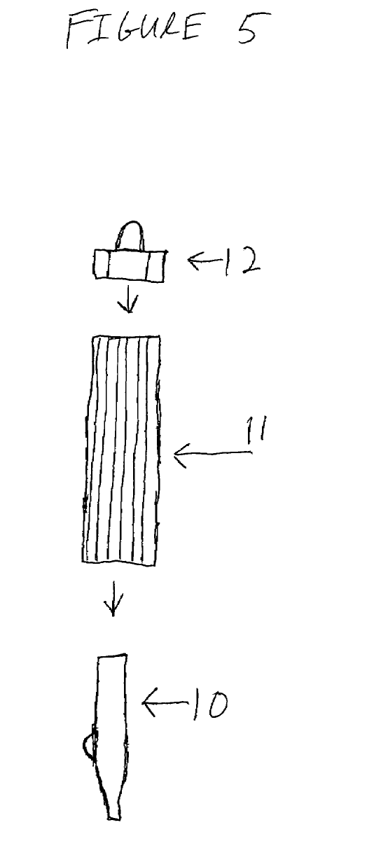

FIG. 4 depicts element 12 while being attached by friction to element 11 is intended to prevent graphite sticks from releasing out of elements 13 in FIG. 3. Element 12 is also intended to serve as a correction tool for documents. Element 12 consist of a plastic cap that can be manufactured from any plastic deemed durable enough to withstand the rigors of writing. A standard mechanical pencil 10 eraser can be placed on top of element 12. This eraser can be manufactured using any material deemed usable for correcting literary errors. Element 12 must not be glued or attached permanently to element 11. Element 12 must be removable from element 11.

FIG. 5 clarifies that the mechanical pencil 10 with rotating cylinder 11 has three elements (elements 12, 11 and 10) that can be separated from each other.

In summary it can be seen that the mechanical pencil 10 with rotating cylider is comprised of three major elements. These elements are held together by friction alone. The mechanical pencil 10 with rotating cylider as depicted here does not use batteries or any power source except a human hand. Although the mechanical pencil 10 with rotating cylinder 11 can be adapted to use alternative sources of energy to rotate element 11. If used properly the mechanical pencil 10 with rotating cylinder 11 will prevent graphite sticks from breaking or jamming, and allow the user to carry a large amount of graphite sticks.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A mechanical pencil with rotating cylinder for a mechanical pencil with a rotating cylinder that carries a large amount of graphite sticks, and prevents graphite sticks from breaking or jamming within the pencil, comprising:
means for allows the user to write documents;
means for contains smaller cyliders that contain an individual graphite sicks the rotating cylider prevents graphite stcks from jamming and breaking, adjustably connected to said means for allows the user to write documents;
means for the eraser cap prevents the graphite sticks from falling out the back of the rotating cylinder, adjustably connected to said means for contains smaller cyliders that contain an individual graphite stick the rotating cylider prevents graphite sicks from jamming and breaking; and
means for the small cyliders contain a single graphite stick each.

2. The mechanical pencil with rotating cylinder in accordance with claim 1, wherein said means for allows the user to write documents comprises a mechanical pencil.

3. The mechanical pencil with rotating cylinder in accordance with claim 1, wherein said means for contains smaller cyliders that contain an individual graphite stick the rotating cylider prevents graphite sicks from jamming and breaking comprises a rotating cylinder.

4. The mechanical pencil with rotating cylinder in accordance with claim 1, wherein said means for the eraser cap prevents the graphite sticks from falling out the back of the rotating cylinder comprises an eraser cap.

5. The mechanical pencil with rotating cylinder in accordance with claim 1, wherein said means for the small cyliders contain a single graphite stick each comprises a small cylinders.

6. A mechanical pencil with rotating cylinder for a mechanical pencil with a rotating cylinder that carries a large amount of graphite sticks, and prevents graphite sticks from breaking or jamming within the pencil, comprising:
a mechanical pencil, for allows the user to write documents;
a rotating cylinder, for contains smaller cyliders that contain an individual graphite stick the rotating cylider prevents graphite sicks from jamming and breaking, adjustably connected to said mechanical pencil;
an eraser cap, for the eraser cap prevents the graphite sticks from falling out the back of the rotating cylinder, adjustably connected to said rotating cylinder; and
a small cylinders, for the small cyliders contain a single graphite stick each.

7. A mechanical pencil with rotating cylinder for a mechanical pencil with a rotating cylinder that carries a large amount of graphite sticks, and prevents graphite sticks from breaking or jamming within the pencil, comprising:
a mechanical pencil, for allows the user to write documents;
a rotating cylinder, for contains smaller cyliders that contain an individual graphite stick the rotating cylinder prevents graphite sicks from jamming and breaking, adjustably connected to said mechanical pencil;
an eraser cap, for the eraser cap prevents the graphite sticks from falling out the back of the rotating cylinder, adjustably connected to said rotating cylinder; and
a small cylinders, for the small cyliders contain a single graphite stick each.
